(19) United States
(12) Patent Application Publication
(10) Pub. No.: US 2012/0104272 A1
(43) Pub. Date: May 3, 2012

(54) CHARGED PARTICLE GUN AND CHARGED PARTICLE BEAM DEVICE

(75) Inventors: Boklae Cho, Hitachinaka (JP); Shigeru Kokubo, Mito (JP); Hisaya Murakoshi, Tokyo (JP)

(73) Assignee: Hitachi High-Technologies Corporation

(21) Appl. No.: 13/381,343

(22) PCT Filed: Jun. 11, 2010
(86) PCT No.: PCT/JP2010/003892

§ 371 Date: Dec. 28, 2011

(30) Foreign Application Priority Data
Jun. 30, 2009 (JP) 2009-154532

(51) Int. Cl. G21K 5/00; H01J 3/26

(52) U.S. Cl. 250/396 R; 250/492.3

(57) ABSTRACT

The present invention provides a charged particle gun including: a charged particle source (1); an extraction electrode (2); an opening (14) through which a charged particle beam passes; and a barrier provided in an area defined by connecting the charged particle source to the opening, the barrier serving to prevent molecules existing in a downstream vacuum chamber from passing through the opening to adsorb onto the charged particle source. Accordingly, the molecules existing in the downstream lower-vacuum chamber can be prevented from adsorbing onto the charged particle source, so that current noise can be reduced. This enables stable operations of the charged particle beam gun and a charged particle beam device including the charged particle beam gun.

### TECHNICAL FIELD

The present invention relates to a charged particle gun and a charged particle beam device, and more particularly, to an electron gun having a degree of vacuum equal to or more than an ultrahigh vacuum and an electron beam device including the electron gun.

### BACKGROUND ART

Charged particle beam devices need a charged particle source that generates a charged particle beam. An electron microscope that is an example of the charged particle beam devices includes, as the charged particle source, an electron gun such as a thermal electron gun, a thermal field-emission electron gun, a Schottky electron gun, and a field-emission electron gun. In the electron microscope, an electron beam emitted from the electron gun is accelerated, the accelerated beam is made into a thinner electron beam via an electron lens, a sample is radiated and scanned with the thinner beam as a primary electron beam, and electrons scattered from the sample or secondary electrons excited by collision against primary electrons are detected, whereby an image is obtained.

Tungsten is used as the material of an electron source in the case of the field-emission electron gun that operates at room temperature. In addition, tungsten containing zirconia may be used in the case of the Schottky electron gun that operates at a high temperature of 1,500 K or higher.

It is known that, if a residual gas in a vacuum vessel adsorbs onto a surface of the electron source, a current emitted from the electron source becomes unstable. The instability of the emitted current (current noise) becomes more significant as the amount of adsorption gas increases, and the electron source is eventually broken after an abrupt increase of current.

In order to emit an electron beam with an excellent amount of current from the electron source over a long period of time, it is necessary to keep the neighborhood of the electron source at a degree of vacuum (10⁻⁷ to 10⁻⁸ Pa) equal to or more than an ultrahigh vacuum for the purpose of reducing the amount of adsorption gas. Accordingly, a method of differential pumping has conventionally been adopted as disclosed in Patent Literature 1 and Patent Literature 2.

### CITATION LIST

### Patent Literature

Patent Literature 1: JP Patent Publication (Kokai) No. 2000-195454 A
Patent Literature 2: JP Patent Publication (Kokai) No. 2007-080667 A

### Non Patent Literature

Non Patent Literature 1: S. Yamamoto et al., Surface Science, Volume 61, (1976), p. 535.
Non Patent Literature 2: S. Yamamoto et al., Surface Science, Volume 71, (1978), p. 191.
Non Patent Literature 3: B. Cho et al., Applied Physics Letters, Volume 91, (2007), p. 012105.
Non Patent Literature 4: A. K. Geim and S. Novoselov, Nature Materials, Volume 6, (2007), p. 183.
Non Patent Literature 5: Changgu Lee et al., Science Volume 321, 385 (2008)

### SUMMARY OF INVENTION

### Technical Problem

In the inventions disclosed in Citation List, a leading end of an electron gun and an opening for differential pumping are disposed on a straight line. It is found out that molecules existing in a downstream lower-vacuum chamber pass through the opening to adsorb onto the electron gun, and cause current noise.

In view of the above-mentioned problem, the present invention has an object to stabilize primary charged particles emitted from a charged particle source for a long time, to thereby enable a stable operation of a charged particle beam device.

### Solution to Problem

In order to achieve the above-mentioned object, the present invention provides a charged particle gun including: a charged particle source; and an extraction electrode that extracts a charged particle beam from the charged particle source, the charged particle gun being connected to a pump that exhausts air inside of the charged particle gun, the charged particle gun further including: an opening through which the charged particle beam passes; and a barrier provided in an area defined by connecting the charged particle source to the opening.

### Advantageous Effects of Invention

According to the present invention, molecules existing in a downstream lower-vacuum chamber can be prevented from passing through an opening to adsorb onto a charged particle source, so that current noise can be reduced. This enables a stable operation of a charged particle beam device.

### BRIEF DESCRIPTION OF DRAWINGS

FIG. 1 illustrates a configuration of an ultrahigh vacuum electron gun according to the present invention.

FIG. 2 illustrates a configuration of an ultrahigh vacuum electron gun.

FIG. 3 illustrates a relation between an electron source and openings of respective vacuum chambers.

FIG. 4 is a graph showing a temporal change of a current emitted from a field-emission electron source (gun valve closed state).

FIG. 5 is a graph showing a temporal change of the current emitted from the field-emission electron source (gun valve opened state).

FIG. 6 shows a temporal change of the current emitted from the field-emission electron source.

FIG. 7 each illustrate a configuration of the ultrahigh vacuum electron gun according to the present invention.

FIG. 8 illustrates a configuration of the ultrahigh vacuum electron gun including a graphene sheet according to the present invention.

FIG. 9 each illustrate a relation between an electron gun and openings according to the present invention.

### DESCRIPTION OF EMBODIMENTS

The principle of the present invention is described before embodiments of the invention of the present application are described.

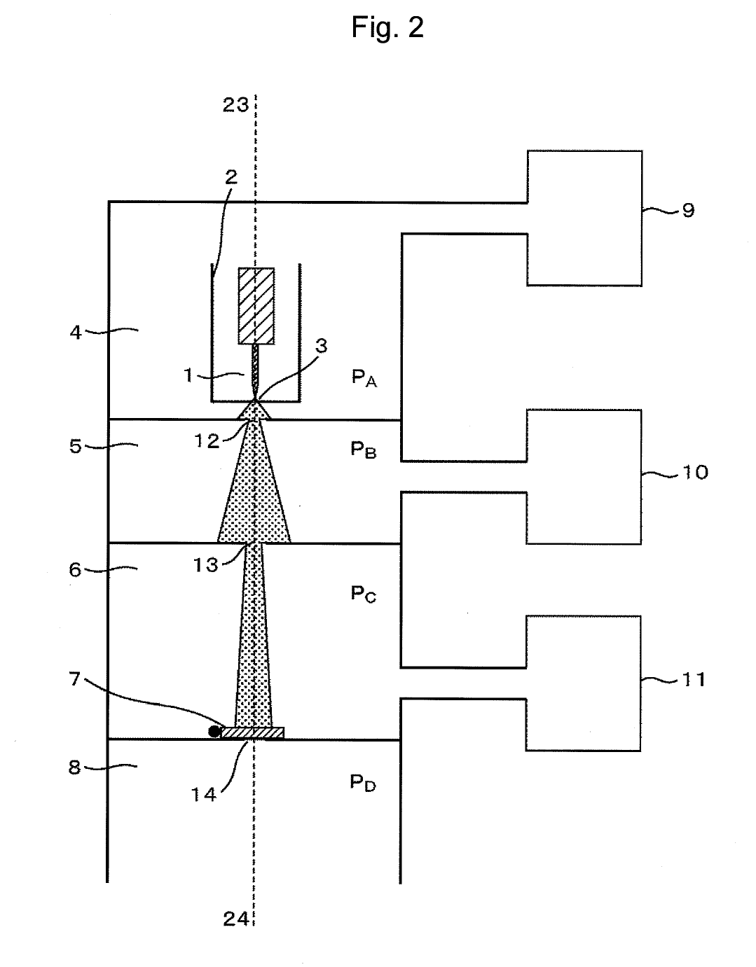

A field-emission electron gun of FIG. 2 is examined in comparison with the present invention.

FIG. 2 includes an electron source 1 and an extraction electrode 2. An extraction voltage is applied to the extraction electrode 2. Electrons are emitted from the electron source 1 by the extraction voltage. The emitted electrons are called primary electron beam. The primary electron beam is accelerated by an acceleration electrode. In FIG. 2, a partition between a vacuum chamber A 4 and a vacuum chamber B 5 functions as the acceleration electrode.

In addition, the insides of the vacuum chamber A 4, the vacuum chamber B 5, and a vacuum chamber C 6 are baked in order to bring the inside of an electron gun chamber into an ultrahigh vacuum. Deflectors and the like disposed in these vacuum chambers are resistant to ultrahigh vacuum (materials that are resistant to baking and do not easily emit gas).

In this example, the electron gun chamber is partitioned into the plurality of vacuum chambers, and differential pumping is performed by an ion pump. The respective vacuum chambers are connected to one another via openings which each have a diameter of 1 mm or less and through which an electron beam passes. The conductance of the openings (how easily gas flows through the openings) is low, and hence there is at least a double-digit difference in degree of vacuum between upstream and downstream of each opening.

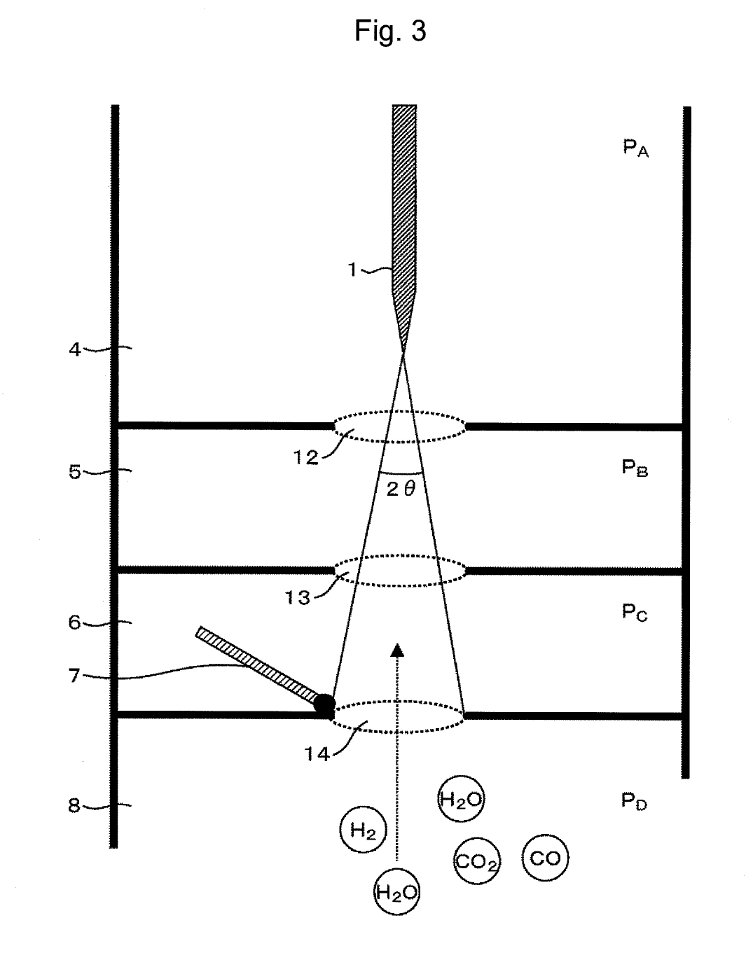

In the configuration of FIG. 2, the electron source 1 and the openings of the respective vacuum chambers are disposed on a straight line (on an axis on which the electron beam passes), and as illustrated in FIG. 3, an opening C 14 having a half angle θ (or solid angle α=πθ²) with respect to the electron source 1 is located in front. Accordingly, gas molecules that pass through the openings from the downstream lower-vacuum chamber D 8 at an angle equal to or less than the half angle θ adsorb onto the electron source 1. Particularly in the case of an ultrahigh vacuum, these gas molecules are extremely unlikely to be scattered by another gas, and thus linearly move to adsorb onto the electron source 1. Then, an experiment proves that these molecules cause current noise.

The number of gas molecules existing in the vacuum chamber A 4 having a temperature T and a pressure P_{A} is n_{A}=P_{A}·kT per unit volume, and the number of molecules that reach a surface of the electron source is J_{A}=1/4·n_{A}·v_{A} per unit time and unit volume, where k represents a Boltzmann constant and v_{A} represents an average speed of the molecules.

The pressure P_{A} in the vacuum chamber A 4 in which the electron source is disposed is at a 10⁻⁸ Pa level, and one layer of gas molecules adsorbs onto the surface of the electron source disposed therein for several tens of minutes. On the other hand, a pressure P_{D} in the vacuum chamber D 8 downstream of the electron gun is at a 10⁴ Pa level or more, and the number of molecules that pass through the opening C 14 having the half angle θ to reach the electron source 1 is J_{D}=1/8·n_{D}·v_{D}·θ² per unit time and area. θ² is at a 10⁻⁵ level, but n_{D} is equal to or more than 10⁴ times n_{A}. Accordingly, the number J_{D} of gas molecules that pass through the opening C 14 to reach the electron source 1 is equal to or more than one-tenth of the number J_{A} deriving from a residual gas in the vacuum chamber A 4.

The type of gas can further come to an issue. The vacuum chamber A 4 is subjected to baking at generally 150° C. or higher, and chief components of the residual gas remaining therein are hydrogen molecules. On the other hand, the vacuum chamber D 8 includes members weak against heat, such as a magnetic lens, and thus cannot be subjected to baking, and chief components of the residual gas remaining therein are water molecules, carbon dioxide molecules, carbon monoxide molecules, and the like. It is found out that these molecules cause large current noise when adsorbing onto the electron source. The hydrogen molecules hardly cause noise (Non Patent Literatures 1 and 2), and hence studies of the inventors of the present invention reveal that the cause of current noise is these molecules that pass through the openings to adsorb onto the electron source 1.

Contents thereof are described below.

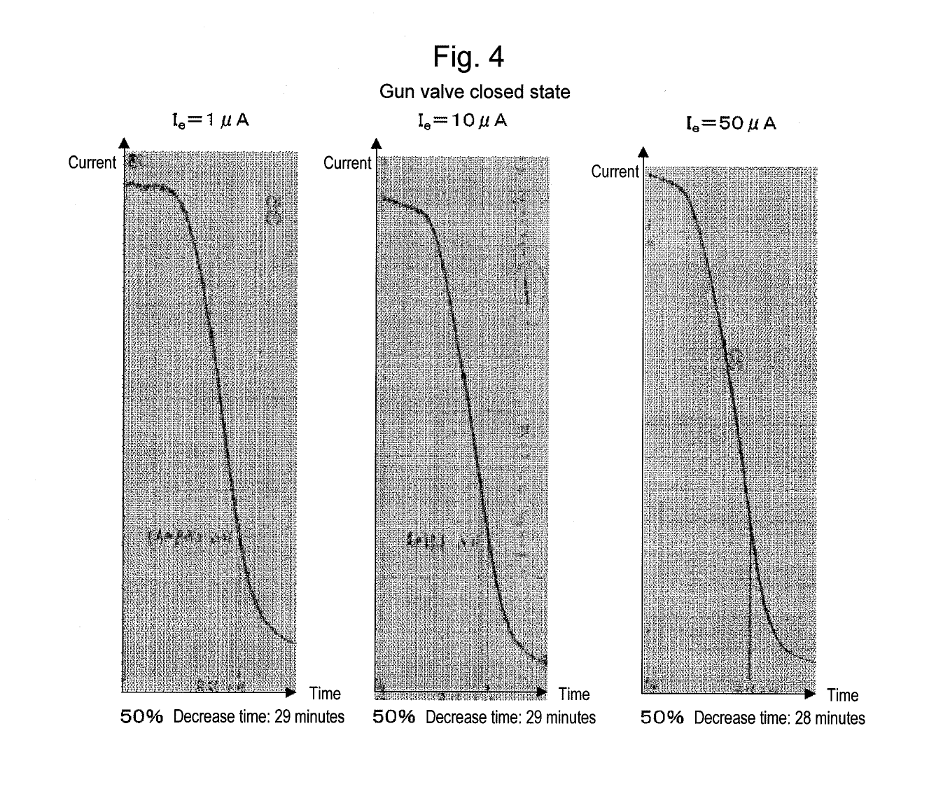

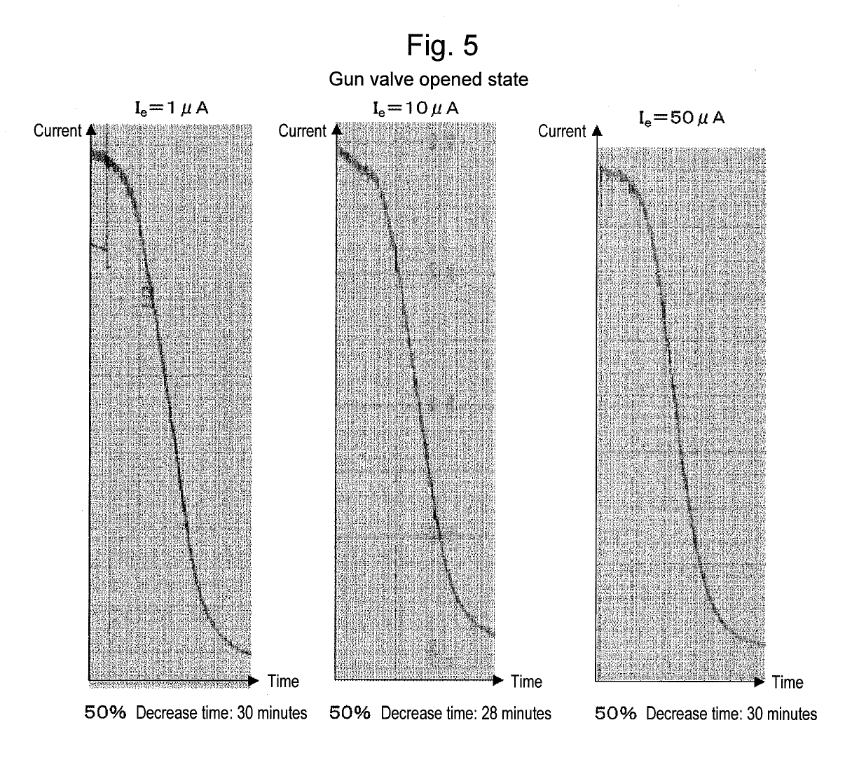

A mechanism for a gun valve 7 is provided at the opening between the vacuum chamber C 6 and the vacuum chamber D 8. When the gun valve 7 is opened, gas molecules pass through the opening C 14 to enter the vacuum chamber C 6 for the electron gun from the downstream vacuum chamber D 8, and a pressure P_{C} in the vacuum chamber C 6 for the electron gun increases from a 10⁻⁸ Pa level to a 10⁻⁶ Pa level. On the other hand, the pressure P_{A} in the vacuum chamber A 4 and a pressure P_{B} in the vacuum chamber B 5 are kept at a 10⁻⁸ Pa level by an operation of a differential pumping system, and particularly the pressure P_{A} in the vacuum chamber A is not changed by the opening/closing of the gun valve 7. As shown in FIG. 4 and FIG. 5, an emitted current decrease time τ is not changed by the valve opening/closing, and this backs up that the valve opening/closing has almost no influence on the pressure around the electron source in the vacuum chamber A 4 for the electron gun.

Note that the emitted current decrease time τ and the pressure P have an inverse relationship, and τ·P is constant (Non Patent Literature 3).

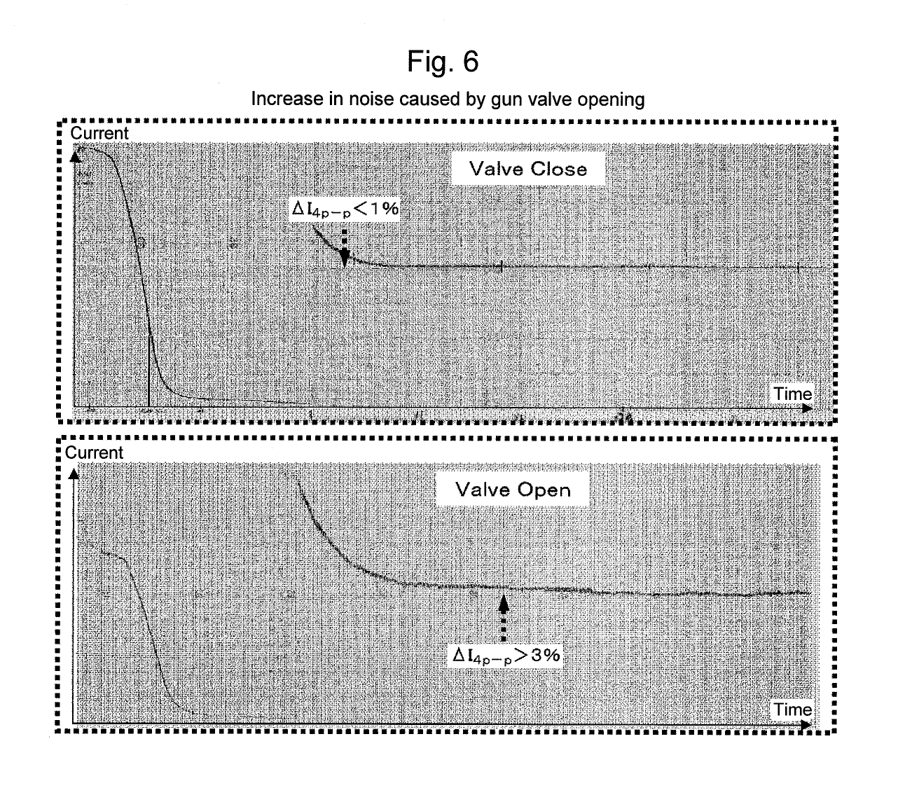

Meanwhile, the opening/closing of the valve 7 has a large influence on current noise. As shown in FIG. 6, when the valve 7 is closed, the current noise is about 1% from 3 hours to 5 hours after flushing, but when the valve is opened, the current noise increases to 5% or more, that is, 5 times or more.

This fact proves that the cause of an increase in current noise is these molecules that pass through the openings to adsorb onto the electron source.

In view of the above, in the present invention, a barrier is provided in an area defined by connecting the electron source 1 to the opening of the downstream lower-vacuum chamber D 8. This prevents gas molecules that pass through the openings from the downstream lower-vacuum chamber D 8 at an angle equal to or less than the half angle θ from adsorbing onto the electron source 1, so that current noise can be suppressed.

Hereinafter, embodiments of the present invention are described with reference to the drawings.

### Embodiment 1

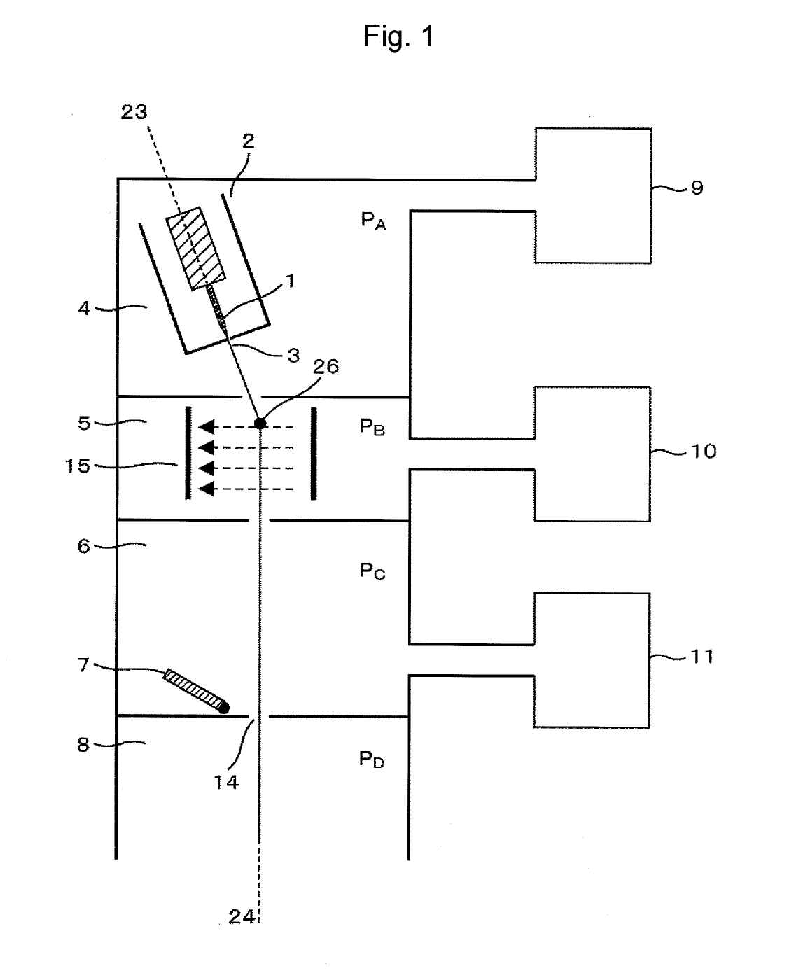

FIG. 1 is a schematic view illustrating a configuration of an ultrahigh vacuum electron gun according to an embodiment of the present invention. Components corresponding to those in FIG. 2 are denoted by the same reference signs. The ultrahigh vacuum electron gun of the present invention has: an electron source optical axis ZS 23 on which the field-emission electron source 1 and an aperture 3 of the extraction electrode 2 are disposed; and a downstream optical axis ZB 24 on which the opening C 14 is disposed.

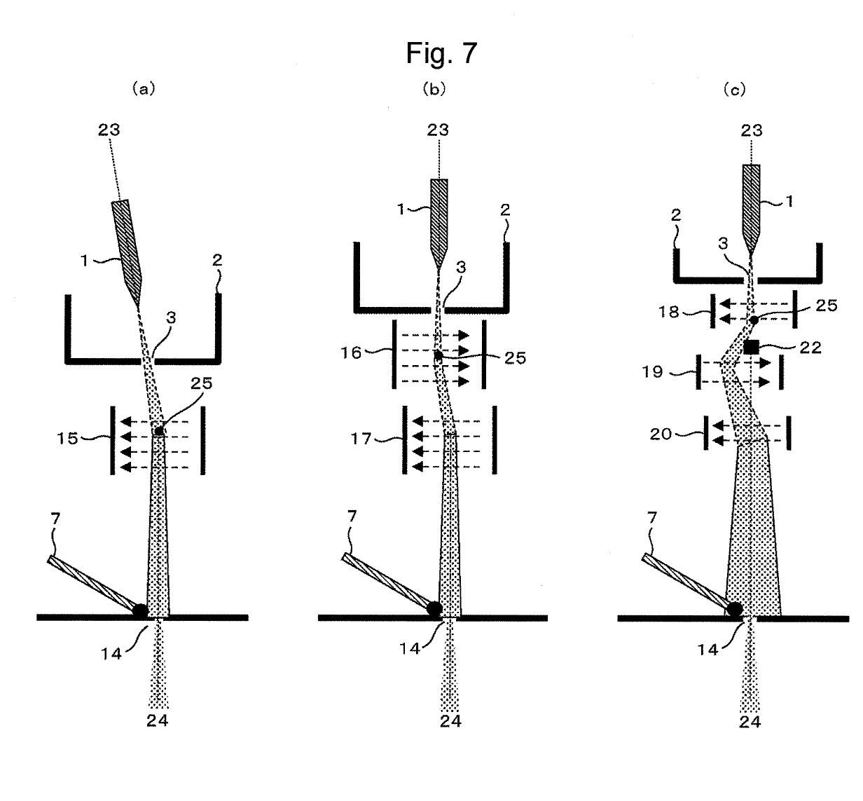

As illustrated in FIG. 1 and FIG. 7(a), in the electron gun of the present invention, the electron source optical axis ZS 23 on which the electron source 1 and the aperture 3 of the extraction electrode 2 are disposed obliquely intersects the optical axis ZB 24 on which the opening C 14 is disposed. Hence, if gas molecules that pass through the opening C 14 from the downstream vacuum chamber 8 to enter the electron gun linearly travel, the gas molecules cannot pass through the extraction electrode 3 to adsorb onto the electron source 1. In this case, the extraction electrode 2 and the partition between the vacuum chamber A 4 and the vacuum chamber B 5 each function as a barrier.

As illustrated in FIG. 1 and FIG. 7(a), a deflector 15 is provided at an intersection point between the electron source optical axis ZS 23 and the downstream optical axis ZB 24. A deflection point 26 of the electron beam is located in the ultrahigh-vacuum chamber having a pressure kept at a 10⁻⁷ to 10⁻⁸ Pa level.

The deflector 15 that deflects the electron beam may be of electrostatic type or of magnetic field type. In the case where the deflector is disposed in the vacuum chamber, the deflector is resistant to ultrahigh vacuum, and is subjected to baking and the like. In the case of the electrostatic type, the deflector 15 is disposed in the vacuum chamber, and the used deflector needs to withstand a baking temperature of 100° C. or higher. In the case of a magnetic field lens, the deflector 15 can be disposed outside of the vacuum chamber B 5 and the vacuum chamber C 6, and hence a problem of gas generated from the magnetic field lens does not arise. Note that, because a magnetic field coil is provided to the electron gun, it is desirable to use a magnetic field coil that can withstand a baking temperature of 100° C. or higher.

The electron beam emitted from the electron source 1 on the electron source optical axis ZS 23 is deflected by the deflector 15, so that the axis of the electron beam is adjusted so as to coincide with the downstream optical axis ZB 24.

### Embodiment 2

In FIG. 7(b), the electron source optical axis ZS 23 on which the electron source 1 and the aperture 3 of the extraction electrode 2 are disposed is parallel to the downstream optical axis ZB 24 on which the opening C 14 is disposed, and these axes are shifted by a deflector 16 and a deflector 17 so as not to coincide with each other. Hence, if gas molecules that pass through the opening C 14 from the vacuum chamber D 8 to enter the electron gun linearly travel, the gas molecules cannot pass through the extraction electrode 3. In this case, the extraction electrode 2 functions as a barrier.

As illustrated in FIG. 7(b), the electron beam emitted from the electron source 1 on the electron source optical axis ZS 23 is deflected by the upper deflector 16 to the outside of the electron source optical axis ZS 23. The deflected electron beam is shifted by the lower deflector 17 by the same amount in the opposite direction to the deflection direction of the upper deflector 16, so that the axis of the deflected electron beam is adjusted so as to coincide with the downstream optical axis ZB 24.

An object of the present invention is achieved if the shift amount of the axis is such an amount that allows the extraction electrode 2 to fall within an area defined by connecting a leading end of the electron source 1 to the opening C 14.

### Embodiment 3

As illustrated in FIG. 7(c), in the ultrahigh vacuum electron gun of the present invention, the optical axis ZS 23 on which the electron source 1 and the aperture 3 of the extraction electrode 2 are disposed coincides with the optical axis ZB 24 on which the opening C 14 is disposed, and a stopper 22 against which gas molecules collide is provided on an extension of the optical axes ZS 23 and ZB 24. This can prevent gas molecules that pass through the opening C 14 from the downstream vacuum chamber 8 to enter the electron gun from adsorbing onto the electron source 1. In this case, the stopper 22 functions as a barrier.

As illustrated in FIG. 7(c), the electron beam emitted from the electron source 1 on the electron source optical axis ZS 23 is deflected twice by a deflector 18 and a deflector 19 to take a detour around the stopper 22, so that the axis of the electron beam is adjusted by deflection of a deflector 20 so as to coincide with the downstream optical axis ZB 24.

An object of the present invention is achieved if the stopper 22 has such a size that allows the stopper 22 to fall within the area defined by connecting the leading end of the electron source 1 to the opening C 14.

The stopper 22 can be used not only in the present embodiment but also in Embodiment 1 and Embodiment 2.

Also in Embodiments 1 to 3, the deflector 15 that deflects the electron beam may be of electrostatic type or of magnetic field type. In the case where the deflector is disposed in the vacuum chamber, the deflector is resistant to ultrahigh vacuum, and is subjected to baking and the like. In the case of the electrostatic type, the deflector 15 is disposed in the vacuum chamber, and the used deflector needs to withstand a baking temperature of 100° C. or higher. In the case of a magnetic field lens, the deflector 15 can be disposed outside of the vacuum chamber B 5 and the vacuum chamber C 6, and hence a problem of gas generated from the magnetic field lens does not arise. Note that, because a magnetic field coil is provided to the electron gun, it is desirable to use a magnetic field coil that can withstand a baking temperature of 100° C. or higher.

In addition, in the embodiments, it is assumed that the place in which gas molecules that cause current noise exist is the vacuum chamber D 8, but if there is another vacuum chamber in which gas molecules that cause current noise exist, this vacuum chamber corresponds to the vacuum chamber D 8.

### Embodiment 4

Description is given of an embodiment in which a graphene sheet is used as a barrier that blocks molecules.

The graphene sheet is a thin gauze-like material made of carbon atoms, is an extremely thin film having a thickness corresponding to one to a few atoms, and is known as having the highest tensile strength among all materials (Non Patent Literatures 4 and 5).

A surface of the graphene sheet is chemically stable, gas molecules do not easily adsorb onto the surface thereof, and hence damage thereto caused by the electron beam is small. In a scanning electron microscope image of a graphene sheet using an electron beam with an energy of several kilo-electron volts, a substance under the graphene sheet can be completely seen through. This means that even a low-energy electron beam can be transmitted through the graphene sheet at a high rate.

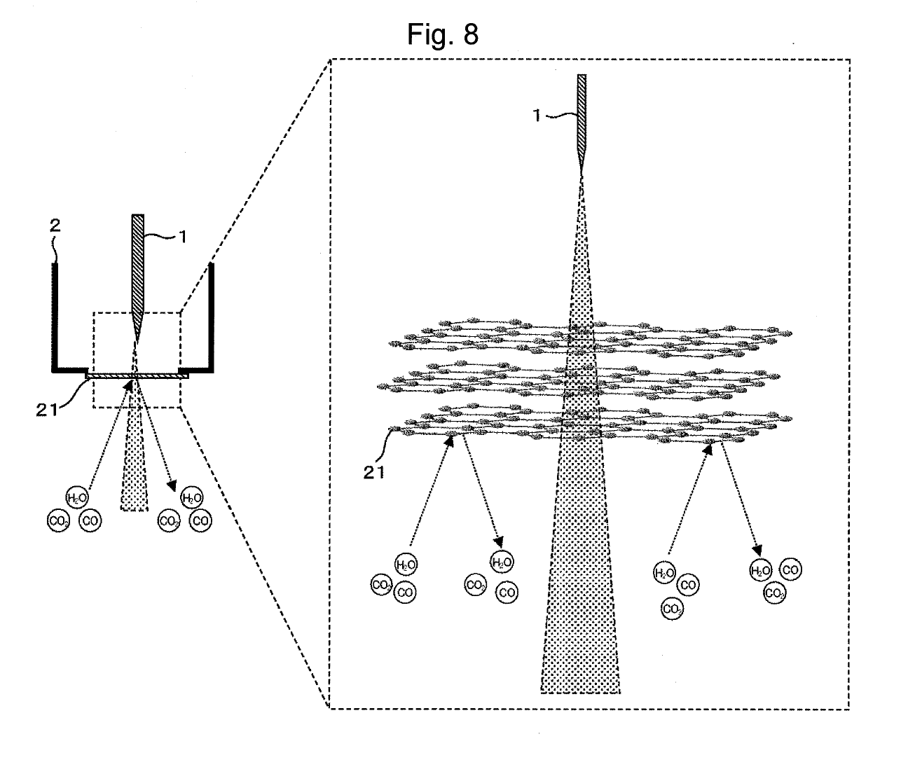

Accordingly, as illustrated in FIG. 8, a graphene film 21 having a thickness of several nanometers or less is provided between the electron source 1 and the opening C 14. The graphene film 21 allows the electron beam to pass therethrough, but does not allow gas molecules to pass therethrough, whereby the gas molecules from the downstream vacuum chamber D 8 are prevented from reaching the electron source 1. In this case, the graphene sheet functions as a barrier.

Note that the graphene sheet of the present embodiment produces an effect of reducing current noise at whichever position the graphene sheet is disposed between the electron source 1 and the vacuum chamber in which a large number of gas molecules that cause the current noise exist.

In addition, effects of the invention of the present application can be enhanced by applying the graphene sheet of the present embodiment to FIG. 2 or by further applying the graphene sheet of the present embodiment to any of Embodiments 1 to 3.

### Embodiment 5

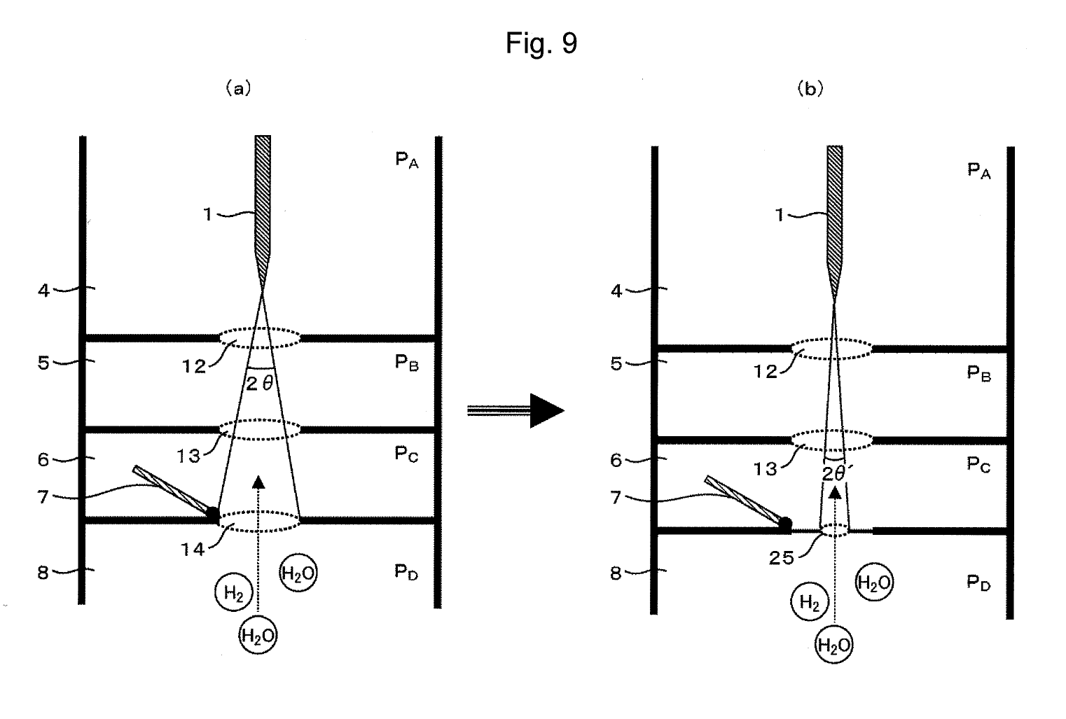

The number of gas molecules that travel from the downstream vacuum chamber to adsorb onto the electron source 1 can be reduced by changing the size of the opening in FIG. 9(a) to such a size as illustrated in FIG. 9(b).

Hydrogen molecules and the like existing in the vacuum chamber A 4 adsorb onto the electron gun 1 with the passage of time. Flushing is regularly performed in order to blow off the adsorbing molecules. If the time until current noise is caused by the adsorption of gas molecules existing in the vacuum chamber D 8 is longer than a cycle of the flushing, a problem does not arise in a stable operation of an electron beam device.

According to an experiment, the above-mentioned object can be achieved by providing an opening 25 having a solid angle of 10⁻⁶ steradian or less with respect to the electron source 1.

Note that the cycle of the flushing against the adsorption of the hydrogen molecules existing in the vacuum chamber A 4 may be determined in comparison with the time until current noise occurs after the gun valve 7 is closed.

### Embodiment 6

In addition, in order to reduce the number of gas molecules existing in the downstream vacuum chamber D 8, the inside of the vacuum chamber D 8 can be baked at 100° C. or higher. In addition, a low gas emitting material such as electrolytic composite polishing stainless steel and pure chromium-oxidized film stainless steel is used as the material of the downstream vacuum chamber 8. In this way, the pressure in the downstream vacuum chamber can be kept at 10⁻⁶ Pa or less, and the number of gas molecules that travel from the downstream vacuum chamber to adsorb onto the electron source 1 can be reduced.

Further, it is conceivable to dispose a structure for adsorbing molecules that cause electron noise, between the electron source 1 and the vacuum chamber D 8. A specific example thereof includes disposing a getter pump.

The present invention can be applied to a charged particle beam device including a charged particle gun that requires an ultrahigh vacuum, such as a field-emission electron gun (particularly, a cold-cathode field-emission electron gun) and a Schottky electron gun.

### REFERENCE SIGNS LIST

1 electron source
2 extraction electrode
3 aperture
4 vacuum chamber A
5 vacuum chamber B
6 vacuum chamber C
7 gun valve
8 vacuum chamber D
9, 10, 11 ion pump
12 opening A
13 opening B
14 opening C
16, 17, 18, 19, 20 deflector
21 graphene sheet
22 stopper
23 electron source optical axis
24 downstream optical axis
25 opening
26 deflection point of electron beam

1. A charged particle gun comprising:
a charged particle source; and
an extraction electrode that extracts a charged particle beam from the charged particle source,
the charged particle gun being connected to a pump that exhausts air inside of the charged particle gun,
the charged particle gun further comprising:
an opening through which the charged particle beam passes; and
a barrier provided in an area defined by connecting the charged particle source to the opening.

2. The charged particle gun according to claim 1, wherein
the barrier prevents gas molecules flowing in through the opening from adsorbing onto the charged particle source.

3. The charged particle gun according to claim 1, wherein
the barrier is the extraction electrode.

4. The charged particle gun according to claim 3, wherein:
a direction of the charged particle source is oblique to a normal to the opening;
the charged particle gun further comprises a deflector that deflects the charged particle beam; and
the charged particle beam emitted from the charged particle source is deflected by the deflector to pass through the opening.

5. The charged particle gun according to claim 3, further comprising a plurality of deflectors that each deflect the charged particle beam, wherein
the charged particle beam is deflected by the plurality of deflectors.

6. The charged particle gun according to claim 1, further comprising a plurality of deflectors that each deflect the charged particle beam, wherein
the barrier is provided between the plurality of deflectors.

7. The charged particle gun according to claim 1, wherein
the barrier is a graphene film.

8. The charged particle gun according to claim 1, wherein
the inside of the charged particle gun is baked, and has a degree of vacuum that is kept at between 10⁻⁷ Pa and 10⁻⁸ Pa by the pump.

9. A charged particle gun comprising:
a charged particle source; and
an extraction electrode that extracts a charged particle beam from the charged particle source,
the charged particle gun being connected to a pump that exhausts air inside of the charged particle gun,
the charged particle gun further comprising:
an opening through which the charged particle beam passes; and
a valve that closes the opening, wherein
a size of the opening is equal to or less than 10⁻⁶ steradian with respect to the charged particle source.

10. A charged particle beam device comprising a charged particle gun including:
a charged particle source; and
an extraction electrode that extracts a charged particle beam from the charged particle source,
the charged particle gun being connected to a pump that exhausts air inside of the charged particle gun,
the charged particle gun further including:
an opening through which the charged particle beam passes; and
a barrier provided in an area defined by connecting the charged particle source to the opening.

11. A charged particle beam device comprising a charged particle gun including:
a charged particle source; and
an extraction electrode that extracts a charged particle beam from the charged particle source,
the charged particle gun being connected to a pump that exhausts air inside of the charged particle gun,
the charged particle gun further including an opening through which the charged particle beam passes, wherein
an outer part of the charged particle gun is formed of electrolytic composite polishing stainless steel or pure chromium-oxidized film stainless steel.
